(19) United States
(12) Patent Application Publication
(10) Pub. No.: US 2023/0413336 A1
(43) Pub. Date: Dec. 21, 2023

(54) FREQUENCY HOPPING FOR MULTIPLE PRACH TRANSMISSIONS OF A PRACH REPETITION

(71) Applicants: Gang Xiong, Beaverton, OR (US); Yingyang Li, Beijing (CN); Debdeep Chatterjee, San Jose, CA (US); Yi Wang, Beijing (CN); Prerana Rane, Newark, CA (US)

(72) Inventors: Gang Xiong, Beaverton, OR (US); Yingyang Li, Beijing (CN); Debdeep Chatterjee, San Jose, CA (US); Yi Wang, Beijing (CN); Prerana Rane, Newark, CA (US)

(21) Appl. No.: 18/242,595

(22) Filed: Sep. 6, 2023

Related U.S. Application Data
(60) Provisional application No. 63/410,565, filed on Sep. 27, 2022.

(51) Int. Cl. H04W 74/08; H04B 1/713; H04L 5/00

(52) U.S. Cl. CPC H04W 74/0833; H04L 5/0048; H04B 1/713

(57) ABSTRACT

A user equipment (UE) configured for operation in a fifth-generation (5G) new radio (NR) network may perform frequency hopping for physical random access channel (PRACH) repetition for a four-step random access channel (RACH) procedure. The UE may encode a PRACH preamble for multiple PRACH transmissions of the PRACH repetition in accordance with the number of repetitions and each of the multiple PRACH transmissions of the PRACH repetition may be transmitted in accordance with frequency hopping. Each of the multiple PRACH transmissions comprises a same PRACH preamble transmitted in each of a plurality of PRACH occasions.

### PRIORITY CLAIM

This application claims the benefit of priority under 35 U.S.C. 119(e) to U.S. Provisional Patent Application Ser. No. 63/410,565, filed Sep. 27, 2022 [reference number AE9304-Z] which is incorporated herein by reference in its entirety.

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

User Equipment in 5G and 6G systems use PRACH (Physical Random Access Channel) transmissions for several reasons. For example, PRACH transmissions are important for Initial access and synchronization: PRACH is used by UEs to initially access the network and synchronize with the base station before establishing a connection. The random access procedure allows the UE to get uplink timing alignment and request resources for further communications. PRACH transmissions are also important for scheduling requests: PRACH is used by UEs to send scheduling requests to the base station when they need uplink resources to transmit data. The random access procedure is used to quickly request uplink grants from the base station. PRACH transmissions are also important for handover requests: During mobility, PRACH is used by UEs to send handover requests to target base stations during the handover procedure. This allows quick establishment of the connection with the new base station. PRACH transmissions are also important for recovery from radio link failure: If the radio link fails, the UE can use PRACH to try to re-establish the connection with the base station or find a new base station. This provides reliability. PRACH transmissions are also important for collision resolutions: The PRACH resources and preamble sequences allow multiple UEs to transmit at the same time. The random access procedure defines mechanisms to resolve any collisions that may occur. The PRACH provides efficient procedures for initial access, uplink synchronization, scheduling requests, handover, and recovery in 5G NR systems.

One issue with PRACH transmissions is that they may not always be received properly. Thus, there are general needs to make PRACH transmissions more robust.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 illustrates a four-step RACH procedure, in accordance with some embodiments.

FIG. 3A illustrates a first example of a frequency hopping pattern determined based on valid time-domain PRACH occasion index, in accordance with some embodiments.

FIG. 3B illustrates a second example of a frequency hopping pattern determined based on valid time-domain PRACH occasion index, in accordance with some embodiments.

FIG. 3C illustrates an example of a frequency hopping pattern determined based on a PRACH slot index, in accordance with some embodiments.

FIG. 3D illustrates an example of a frequency hopping pattern determined based on a subframe index, in accordance with some embodiments.

FIG. 4 illustrates a functional block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a user equipment (UE) configured for operation in a fifth-generation (5G) new radio (NR) network or a sixth-generation (6G) network. In some embodiments, the UE may be configured to decode signalling received from a generation Node B (gNB) to configure the UE for frequency hopping for physical random access channel (PRACH) repetition for a four-step random access channel (RACH) procedure. The signalling may include a number of repetitions. In these embodiments, the UE may encode a PRACH preamble for multiple PRACH transmissions of the PRACH repetition in accordance with the number of repetitions. In these embodiments, each of the multiple PRACH transmissions of the PRACH repetition is transmitted in accordance with the frequency hopping. In these embodiments, each of the multiple PRACH transmissions comprises a same PRACH preamble transmitted in each of a plurality of PRACH occasions. In these embodiments, the UE may include memory configured to store the PRACH preamble. These embodiments as well as others are described in more detail below.

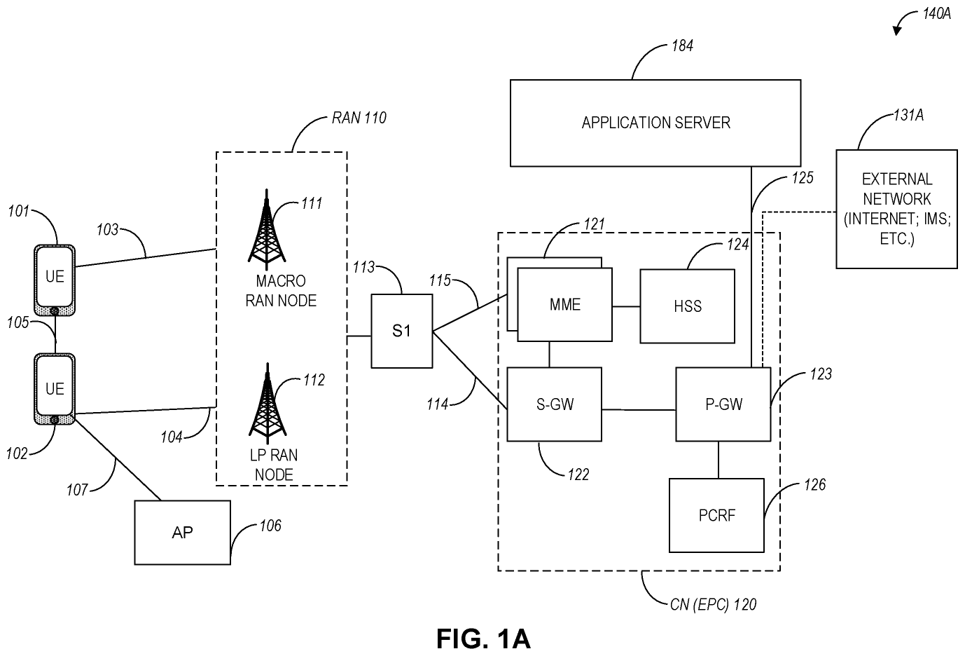

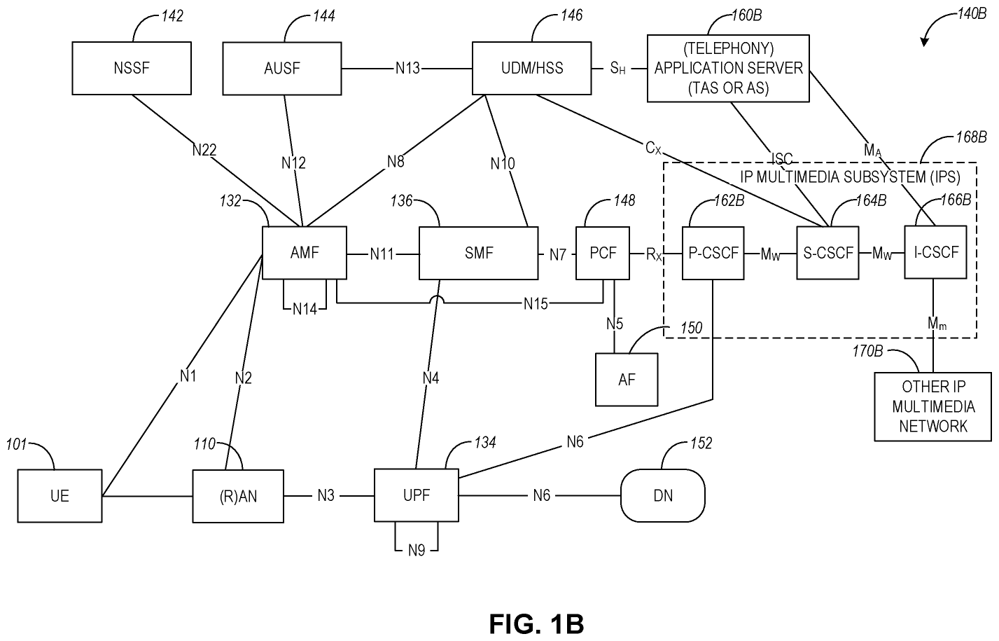

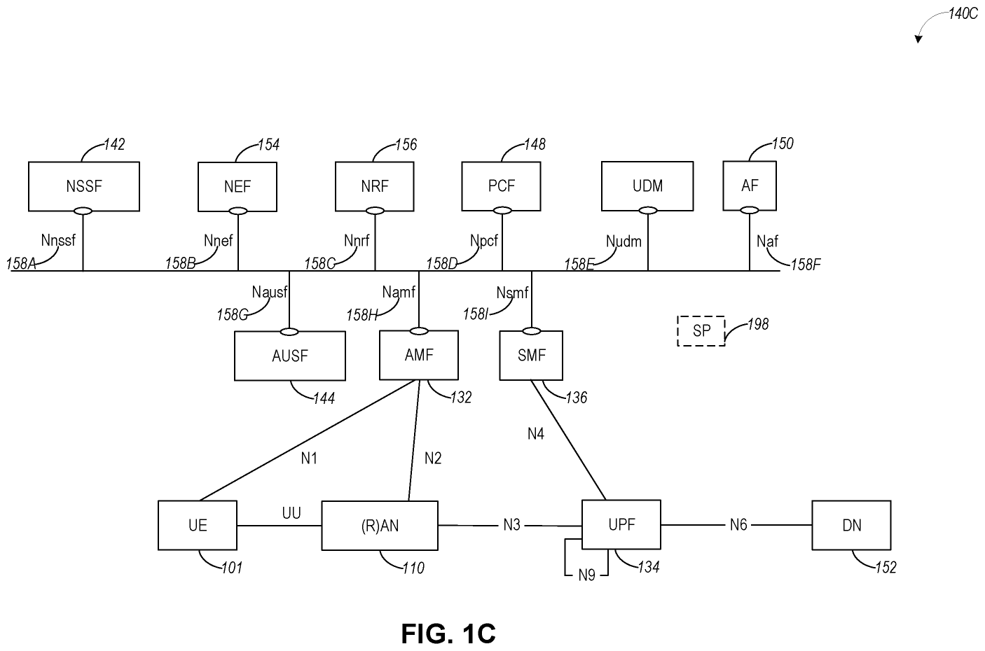

FIG. 1A illustrates an architecture of a network in accordance with some embodiments. The network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UE 101 and UE 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UE 101 and UE 102 can comprise an Internet-of-Things (IoT) UE or a Cellular IoT (CIoT) UE, which can comprise a network access layer designed for low-power IoT applications utilizing short-lived UE connections. In some embodiments, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UE 101 and UE 102 can include enhanced MTC (eMTC) UEs or further enhanced MTC (FeMTC) UEs.

The UE 101 and UE 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the RAN nodes 111 and 112 can be transmission/reception points (TRPs). In instances when the RAN nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes 111 and 112 can terminate the air interface protocol and can be the first point of contact for the UE 101 and UE 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the RAN nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the core network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. In these embodiments, the RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs 134, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

* For cellular systems, coverage is an important factor for successful operation. Compared to LTE, NR can be deployed at relatively higher carrier frequency in frequency range 1 (FR1), e.g., at 3.5 GHz. In this case, coverage loss is expected due to larger path-loss, which makes it more challenging to maintain an adequate quality of service. Typically, uplink coverage is the bottleneck for system operation considering the low transmit power at UE side.

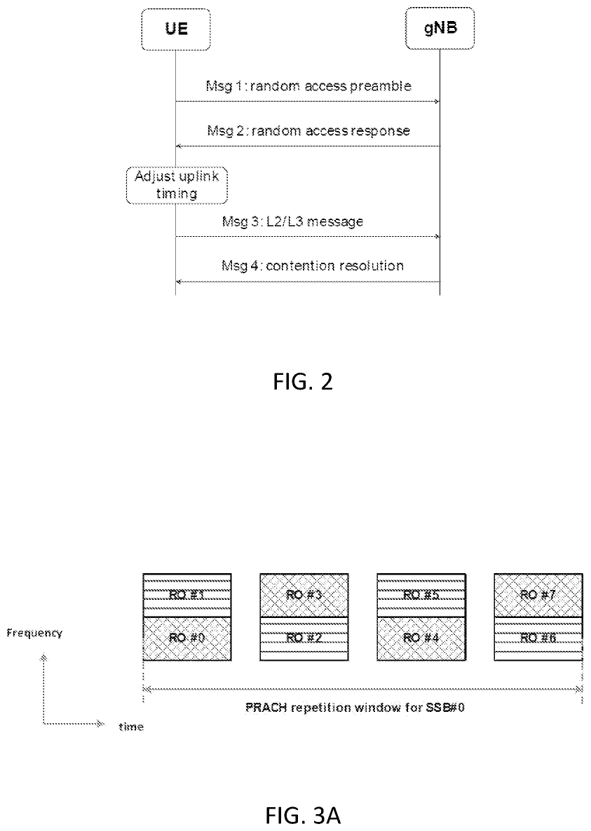

In NR Rel-15, a 4-step procedure was defined. FIG. 2 illustrates the 4-step RACH procedure for initial access. In the first step, UE transmits physical random access channel (PRACH) in the uplink by randomly selecting one preamble signature, which would allow gNB to estimate the delay between gNB and UE for subsequent UL timing adjustment. Subsequently, in the second step, gNB feedbacks the random access response (RAR) which carries timing advanced (TA) command information and uplink grant for the uplink transmission in the third step. The UE expects to receive the RAR within a time window, of which the start and end are configured by the gNB via system information block (SIB).

Note that PRACH transmission is very important for many procedures, e.g., initial access and beam failure recovery. As defined in NR Rel-15, number of repetitions is 2 and 4 for PRACH format 1 and 2, respectively, which can help in improving the coverage for long PRACH format. However, for short PRACH format, repetition is not defined. In order to improve the coverage for PRACH, especially short PRACH format, multiple PRACH transmissions with same or different beams can be considered. When multiple PRACH transmissions are configured during 4-step RACH procedure, frequency hopping can be supported to further improve the coverage for PRACH transmission.

Various embodiments herein provide mechanisms for a frequency hopping pattern for multiple PRACH transmissions. Embodiments may improve PRACH coverage.

Some embodiments are directed to a user equipment (UE) configured for operation in a fifth-generation (5G) new radio (NR) network or a sixth-generation (6G) network. Some embodiments are directed to an apparatus of a UE comprising processing circuitry and memory. In some embodiments, the UE may be configured to decode signalling received from a generation Node B (gNB) to configure the UE for frequency hopping for physical random access channel (PRACH) repetition for a four-step random access channel (RACH) procedure. The signalling may include a number of repetitions. In these embodiments, the UE may encode a PRACH preamble for multiple PRACH transmissions of the PRACH repetition in accordance with the number of repetitions, although the scope of the embodiments is not limited in this respect.

In these embodiments, each of the multiple PRACH transmissions of the PRACH repetition is transmitted in accordance with the frequency hopping. In these embodiments, each of the multiple PRACH transmissions comprises a same PRACH preamble transmitted in each of a plurality of PRACH occasions. In these embodiments, the UE may include memory configured to store the PRACH preamble, although the scope of the embodiments is not limited in this respect.

In some embodiments, the signalling received from the gNB configures the UE for frequency hopping for PRACH repetition using a short PRACH format. In these embodiments, the short PRACH format comprises a preamble with a short sequence having a length of 139 (i.e., L_RA=139). In these embodiments, the short PRACH format may comprise one of formats A1, A2, A3, B1, B2, B3, B4, C0, C2.

In some embodiments, the signalling received from the gNB configures the UE for frequency hopping for PRACH repetition using a long PRACH format. In these embodiments, the long PRACH format comprises a preamble with a long sequence having a length of 839 (i.e., L_RA=839), although the scope of the embodiments is not limited in this respect.

In some embodiments, the UE may be configured for transmission of the multiple PRACH transmissions in one or more different transmit beams or using one or more different spatial domain filters, although the scope of the embodiments is not limited in this respect.

In some embodiments, the signalling received from the gNB configures the UE for frequency hopping for PRACH repetition indicates a frequency resource offset for transmission of the PRACH preambles at different frequencies for the multiple PRACH transmissions. In these embodiments, the frequency resource offset comprises one of a physical resource block (PRB) offset or the PRACH frequency resource offset. In these embodiments, the transmission frequency of each PRACH preamble transmission may be hopped based on the frequency resource offset, although the scope of the embodiments is not limited in this respect.

In some embodiments, the UE may determine a frequency resource offset for the frequency hopping based on a number of PRACH frequency resources provided by a message (i.e., msg1-FDM) received from the gNB. In these embodiments, the frequency resource offset may be based on a number of PRACH occasions (M_{SSB}) in frequency domain which are associated with an Synchronization Signal/PBCH block (SSB). In these embodiments, the SSB may comprise a primary synchronization signal (PSS), a secondary synchronization signal (SSS) and a Physical Broadcast Channel (PBCH) transmitted by the gNB, although the scope of the embodiments is not limited in this respect.

In some embodiments, for the frequency hopping, the UE may determine a frequency hopping pattern for the multiple PRACH transmissions in accordance with valid time-domain PRACH occasion indexes used for the multiple PRACH transmissions. In these embodiments, the valid time-domain PRACH occasion indexes may be mapped to valid PRACH occasions and are associated with a PRACH occasion group. In these embodiments, one PRACH occasion group may consists of N repetitions for multiple PRACH transmissions, although the scope of the embodiments is not limited in this respect.

In some embodiments, the UE may refrain from including any PRACH repetitions in the PRACH occasion group for any time-domain PRACH occasion indices that are mapped to invalid PRACH occasions. In these embodiments, any PRACH repetitions mapped to invalid PRACH occasions are not counted in the total number of repetitions (the number signaled by the gNB), although the scope of the embodiments is not limited in this respect.

In some embodiments, when the PRACH occasions are multiplexed in a frequency domain multiplexing (FDM) manner and each of the PRACH occasions are associated with an Synchronization Signal/PBCH block (SSB), the UE may be configured to randomly select a first PRACH occasion from the PRACH occasion group for a first PRACH repetition and determine a second PRACH occasion based at least in part on a frequency resource offset, although the scope of the embodiments is not limited in this respect.

In some embodiments, the signalling to configure the UE for frequency hopping comprises one of a DCI format, dedicated RRC signalling, NR remaining minimum system information (RMSI), and NR other system information (OSI). In these embodiments, a DCI format may be used to dynamically indicate the UE for multiple PRACH transmissions of the PRACH repetition transmitted in accordance with the frequency hopping, although the scope of the embodiments is not limited in this respect.

In some embodiments, the multiple PRACH transmissions of the PRACH repetition transmitted in accordance with the frequency hopping are transmitted as part of the 4-step RACH procedure for initial access, although the scope of the embodiments is not limited in this respect.

In some embodiments, the multiple PRACH transmissions of the PRACH repetition transmitted in accordance with the frequency hopping are transmitted as part of a beam failure recovery (BFR) procedure. In some embodiments, the multiple PRACH transmissions of the PRACH repetition transmitted in accordance with the frequency hopping may be transmitted for other purposes such as a system information (SI) request or handover. In some embodiments, the gNB may configure the UE for the multiple PRACH transmissions of the PRACH repetition transmitted in accordance with the frequency hopping for both FR1 and FR2 frequency ranges. In some embodiments, the gNB may configure the UE for the multiple PRACH transmissions of the PRACH repetition transmitted in accordance with the frequency hopping in the higher frequency ranges (i.e., the 3.5 GHz range of FR1 and FR2) and may disable the multiple PRACH transmissions of the PRACH repetition transmitted in accordance with the frequency hopping in lower frequency ranges (i.e., the 2.5 GHz range of FR1), although the scope of the embodiments are not limited in this respect, although the scope of the embodiments is not limited in this respect.

Some embodiments are directed to a computer-readable storage medium that stores instructions for execution by processing circuitry of a user equipment (UE) configured for operation in a fifth-generation (5G) new radio (NR) network, although the scope of the embodiments is not limited in this respect.

Some embodiments are directed to a generation Node B (gNB) configured for operation in a fifth-generation (5G) new radio (NR) network or a sixth-generation (6G) network. In these embodiments, the gNB may encode signalling for transmission to a user equipment (UE) to configure the UE for frequency hopping for physical random access channel (PRACH) repetition for a four-step random access channel (RACH) procedure. The signalling may indicate a number of repetitions. In these embodiments, the gNB may decode a PRACH preamble received from the UE in multiple PRACH transmissions of the PRACH repetition in accordance with the number of repetitions. In these embodiments, each of the multiple PRACH transmissions of the PRACH repetition is received at different frequencies in accordance with the frequency hopping. In these embodiments, each of the multiple PRACH transmissions comprises a same PRACH preamble transmitted in each of a plurality of PRACH occasions. In these embodiments, the gNB may include memory configured to store the PRACH preamble, although the scope of the embodiments is not limited in this respect.

In some embodiments, the PRACH preamble received from the UE in multiple PRACH transmissions comprises a short PRACH format, the short PRACH format comprising a preamble with a short sequence having a length of 139 bits, although the scope of the embodiments is not limited in this respect.

In some embodiments, the signalling to configure the UE for frequency hopping for PRACH repetition is encoded to indicate a frequency resource offset for transmission of the PRACH preambles at the different frequencies for the multiple PRACH transmissions. In these embodiments, the frequency resource offset comprises one of a physical resource block (PRB) offset or the PRACH frequency resource offset, although the scope of the embodiments is not limited in this respect.

Frequency hopping for multiple PRACH transmissions.

As mentioned above, PRACH transmission is very important for many procedures, e.g., initial access and beam failure recovery. As defined in NR Rel-15, number of repetitions is 2 and 4 for PRACH format 1 and 2, respectively, which can help in improving the coverage for long PRACH format. However, for short PRACH format, repetition is not defined. In order to improve the coverage for PRACH, especially short PRACH format, multiple PRACH transmissions with same or different beams can be considered.

When multiple PRACH transmissions are configured during 4-step RACH procedure, frequency hopping can be supported to further improve the coverage for PRACH transmission. Embodiments of frequency hopping for multiple PRACH transmissions are described further below.

In one embodiment, whether frequency hopping for multiple PRACH transmission is enabled or disabled can be configured by higher layers via NR remaining minimum system information (RMSI), NR other system information (OSI) or dedicated radio resource control (RRC) signaling, dynamically indicated in the DCI, or a combination thereof.

In some aspects, a frequency resource offset can be configured by higher layers via NR remaining minimum system information (RMSI), NR other system information (OSI) or dedicated radio resource control (RRC) signaling, dynamically indicated in the DCI, or a combination thereof.

In particular, the frequency resource offset can be defined as the physical resource block (PRB) offset or the PRACH frequency resource offset n_{RA}^{offset}.

Alternatively, frequency resource offset may be determined in accordance with the number of PRACH frequency resource, which is provided by msg1-FDM. In one example, the frequency resource offset n_{RA}^{offset}=└M/2┘, where M equals the higher-layer parameter msg1-FDM. In another example, n_{RA}^{offset}=└M_{SSB}/2┘, where M_{SSB} equals the number of PRACH occasions in frequency domain which are associated with an SSB.

In one option, the specification in Section 5.3.2 in TS 38.211 can be updated as indicated below in underline for PRACH signal generation with frequency hopping.

The time-continuous signal sₗ^{(p, μ)}(t) on antenna port p for PRACH is defined by

$${s}_{l}^{( p , μ )} ( t ) = {\sum }_{k = 0}^{{L}_{RA} - 1} {a}_{k}^{( p , RA )} {e}^{j 2 π ( k + {Kk}_{1} + \overline{k} ) Δ {f}_{RA} ( t - {N}_{CP , l}^{RA} {τ}_{c} - {τ}_{start}^{RA} )} \\ K = Δ f / Δ {f}_{RA} \\ {k}_{1} = {k}_{0}^{μ} + ( {N}_{BWP , i}^{start} - {N}_{grid}^{start , μ} ) {N}_{sc}^{RB} - {N}_{grid}^{size , μ} {N}_{sc}^{RB} / 2 + {n}_{RA}^{start} {N}_{sc}^{RB} + \{ \begin{matrix}{\overline{n}}_{RA} {N}_{RB}^{RA} {N}_{sc}^{RB} & if {L}_{RA} ∈ \{ 139 , 839 \} \\ {\overline{n}}_{RA} {N}_{RB}^{RA} {N}_{sc}^{RB} & if {L}_{RA} ∈ \{ 571 , 1151 \} in FR 2 - 2 \\ ( {N}_{RB , UL , {n}_{0} + {\overline{n}}_{RA}}^{start , μ} - {N}_{RB , UL , {n}_{0}}^{start , μ} ) {N}_{sc}^{RB} & if {L}_{RA} ∈ \{ 571 , 1151 \} in FR 1\end{matrix} \\ {k}_{0}^{μ} = ( {N}_{grid}^{start , μ} + {N}_{grid}^{size , μ} / 2 ) {N}_{sc}^{RB} - ( {N}_{grid}^{start , {μ}_{0}} + {N}_{grid}^{size , {μ}_{0}} / 2 ) {N}_{sc}^{RB} {2}^{{μ}_{0} - μ} \\ where {t}_{start}^{RA} \leq t < {t}_{start}^{RA} + ( {N}_{u} + {N}_{CP , l}^{RA} ) {T}_{c} and \\ where \\ {\overline{n}}_{RA} = \{ \begin{matrix}{n}_{RA} & {n}_{i} mod 2 = 0 \\ ( {n}_{RA} + {n}_{RA}^{offset} ) mod {M}_{SSB} & {n}_{i} mod 2 = 1\end{matrix}$$

M_{SSB} is the number of PRACH occasions that are multiplexed in frequency domain and associated with an SSB.

nᵢ is the physical slot index, PRACH slot index, subframe index in FR1 or 60 kHz slot index in FR2 or system frame number.

Note that in the above update, can be defined in accordance with the following embodiments.

In another embodiment, frequency hopping pattern for multiple PRACH transmissions can be determined in accordance with the valid time-domain PRACH occasion index used for multiple PRACH transmissions.

In some aspects, the time-domain PRACH occasion index can be defined with respect to valid time-domain PRACH occasions only. In particular, a first time-domain PRACH occasion index within a PRACH repetition window can be defined as 0, a second time-domain PRACH occasion index within a PRACH repetition window for the second PRACH repetition can be defined as 1, and so on.

In some aspects, the starting PRACH slot index and the number of repetitions can be configured by higher layers to determine the PRACH repetition window. Alternatively, the starting PRACH slot may be configured by higher layers, and the PRACH repetition window can be determined in accordance with the association between SSB and PRACH occasion. In this case, a UE may not expect that a number of PRACH repetitions may extend beyond a PRACH repetition window. As another alternative, the starting PRACH slots may be determined based on a time-offset and periodicity configured by higher layers, such that the periodicity of the starting PRACH slots is not shorter than the number of PRACH repetitions, e.g., two consecutive starting PRACH slots, that may implicitly define a PRACH repetition window, are at least separated by the number repetitions for the corresponding PRACH configuration.

In some aspects, PRACH repetitions mapped to PRACH occasions that may be invalid and/or cancelled are counted towards the total number of PRACH repetitions. Alternatively, PRACH repetitions mapped to PRACH occasions that may be invalid and/or cancelled are not counted towards the total number of PRACH repetitions. In this case, if a PRACH repetition occasion corresponding to a first starting PRACH slot may overlap with or occur after a second starting PRACH slot, the PRACH occasions corresponding to the second starting PRACH slot may be considered not available, where the second starting PRACH slot occurs later than the first starting PRACH slot.

In some aspects, the time-domain PRACH occasion index can be defined as absolute valid time-domain PRACH occasion index. The absolute valid time-domain PRACH occasion index is restarted every 160 ms.

When more than one PRACH occasions are multiplexed in a frequency domain multiplexing (FDM) manner and the more than one PRACH occasions are associated with an SSB, UE may randomly select a first PRACH occasion from the more than one PRACH occasions for the first PRACH repetitions, and determines a second PRACH occasion based on the frequency resource in the selected first PRACH occasion, frequency hopping pattern and a frequency resource offset. In some aspects, the valid PRACH occasions for the multiple PRACH transmission may or may not be consecutive in time domain.

Further, in one option, UE switches the frequency resource in every K valid time-domain PRACH occasions for multiple PRACH transmissions, where K can be predefined in the specification or configured by higher layer via RMSI, OSI, or RRC signaling. In one example, K=1, which indicates that UE switches the frequency resource in every valid time-domain PRACH occasion.

In another option, K can be determined in accordance with the number of repetitions. In one example, K=└N_{PRACH}^{Repeat}/2┘.

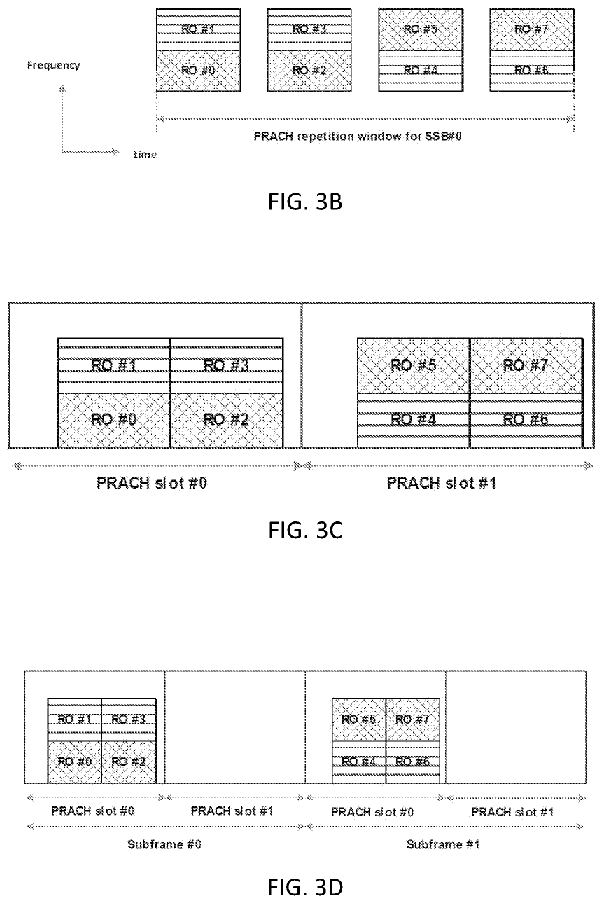

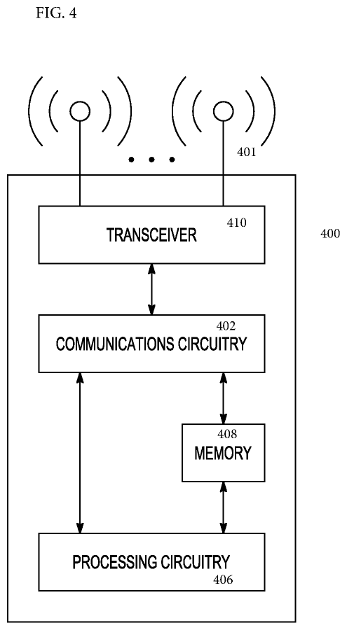

FIG. 3A illustrates one example of frequency hopping pattern determined based on valid time-domain PRACH occasion index. In the example, 2 valid PRACH occasions are multiplexed in a FDM manner. Each SSB is associated with 8 valid PRACH occasions. The number of repetitions is 4 for multiple PRACH transmissions. Based on this option, UE selects second PRACH occasion (RO#1) among two frequency-division multiplexed PRACH occasions. If frequency hopping is configured or enabled for multiple PRACH transmissions, K=1, and frequency resource offset n_{RA}^{offset}=1, UE transmits PRACH repetitions in RO#1, #2, #5 and #6.

FIG. 3B illustrates another example of frequency hopping pattern determined based on a valid time-domain PRACH occasion index. In the example, 2 valid PRACH occasions are multiplexed in a FDM manner. Each SSB is associated with 8 valid PRACH occasions. The number of repetitions is 4 for multiple PRACH transmissions. Based on this option, UE selects the second PRACH occasion (RO#1) among two frequency-division multiplexed PRACH occasions. If frequency hopping is configured or enabled for multiple PRACH transmissions, K=2, and frequency resource offset n_{RA}^{offset}=1, UE transmits PRACH repetitions in RO#1, #3, #4 and #6. This indicates that UE switches the frequency resource in every 2 valid time-domain PRACH occasions for multiple PRACH transmissions.

In another embodiment, frequency hopping pattern for multiple PRACH transmissions can be determined in accordance with one or more following index: physical slot index, PRACH slot index, subframe index, 60 kHz slot index in a system frame and absolute system frame number. In some aspects, for frequency range 1 (FR1), subframe index can be applied while for frequency range 2 (FR2), 60 kHz slot index can be applied for the determination of frequency hopping pattern.

In one option, frequency hopping pattern for multiple PRACH transmissions can be determined in accordance with PRACH slot index and/or system frame index. Further, UE switches the frequency resource in every K PRACH slot for multiple PRACH transmissions, where K can be predefined in the specification or configured by higher layer via RMSI, OSI, or RRC signaling. In one example, K=1, which indicates that UE switches the frequency resource in every PRACH slot. Alternatively, K can be determined in accordance with the number of repetitions. In one example, K=└N_{PRACH}^{Repeat}/2┘. For this option, same frequency resource is allocated for PRACH repetitions in the same PRACH slot.

FIG. 3C illustrates one example of frequency hopping pattern determined based on PRACH slot index. In the example, 2 valid PRACH occasions are multiplexed in a FDM manner. Each SSB is associated with 8 valid PRACH occasions. The number of repetitions is 4 for multiple PRACH transmissions. Based on this option, UE selects second PRACH occasion (RO#1) among two frequency-division multiplexed PRACH occasions. If frequency hopping is configured or enabled for multiple PRACH transmissions, K=1, and frequency resource offset n_{RA}^{offset}=1, UE transmits PRACH repetitions in RO#1, #3, #4 and #6. This indicates that UE switches the frequency resource in every PRACH slot for multiple PRACH transmissions, but uses the same frequency resource for PRACH repetitions in the same PRACH slot.

In another option, frequency hopping pattern for multiple PRACH transmissions can be determined in accordance with subframe index, or 60 kHz slot index and/or system frame index. Further, UE switches the frequency resource in every K PRACH slot for multiple PRACH transmissions, where K can be predefined in the specification or configured by higher layer via RMSI, OSI, or RRC signaling. In one example, K=1, which indicates that UE switches the frequency resource in every PRACH slot. Alternatively, K can be determined in accordance with the number of repetitions. In one example, K=└N_{PRACH}^{Repeat}/2┘. For this option, same frequency resource is allocated for PRACH repetitions in the same subframe or 60 kHz slot.

FIG. 3D illustrates one example of frequency hopping pattern determined based on PRACH slot index. In the example, 2 valid PRACH occasions are multiplexed in a FDM manner. Each SSB is associated with 8 valid PRACH occasions. The number of repetitions is 4 for multiple PRACH transmissions. Further, one PRACH slot (PRACH#0) is allocated in a subframe.

Based on this option, UE selects second PRACH occasion (RO#1) among two frequency-division multiplexed PRACH occasions. If frequency hopping is configured or enabled for multiple PRACH transmissions, K=1, and frequency resource offset n_{RA}^{offset}=1, UE transmits PRACH repetitions in RO#1, #3, #4 and #6. This indicates that UE switches the frequency resource in every subframe for multiple PRACH transmissions, but uses the same frequency resource for PRACH repetitions in the same subframe.

In another option, frequency hopping pattern for multiple PRACH transmissions can be determined in accordance with system frame number. Further, UE switches the frequency resource in every K system frame for multiple PRACH transmissions, where can be predefined in the specification or configured by higher layer via RMSI, OSI, or RRC signaling. In one example, K=1, which indicates that UE switches the frequency resource in every system frame. Alternatively, K can be determined in accordance with the number of repetitions. In one example, K=└N_{PRACH}^{Repeat}/2┘. For this option, same frequency resource is allocated for PRACH repetitions in the same system frame.

In another embodiment, frequency hopping pattern for multiple PRACH transmissions can be determined in accordance with one or more following index: relative physical slot index, relative PRACH slot index, relative subframe index, relative 60 kHz slot index in a system frame and system frame number. In some aspects, for frequency range 1 (FR1), relative subframe index can be applied while for frequency range 2 (FR2), relative 60 kHz slot index can be applied for the determination of frequency hopping pattern.

In one option, frequency hopping pattern for multiple PRACH transmissions can be determined in accordance with relative PRACH slot index and/or relative or absolute system frame index. In some aspects, for relative PRACH slot index, first PRACH slot used for a first PRACH repetition is 0, and relative PRACH slot for other PRACH slot used for the PRACH repetition is defined relative to the first PRACH slot used for the first PRACH repetition. In an example, the first PRACH slot may be identified with respect to an absolute time reference, e.g., one or more combinations of: system frame number, subframe number, slot number for a given numerology, e.g., the numerology of the initial UL BWP, or the numerology of the PRACH transmissions, etc., or relative to another time reference, e.g., of a DL or UL channel or signal, e.g., SSB, e.g., the latest occasion of an associated SSB.

Further, UE can be configured to switch the frequency resource in every K PRACH slot index for multiple PRACH transmissions, where K can be predefined in the specification or configured by higher layer via RMSI, OSI, or RRC signaling. In one example, K=1, which indicates that UE switches the frequency resource in every PRACH slot. Alternatively, K can be determined in accordance with the number of repetitions. In one example, K=└N_{PRACH}^{Repeat}/2┘. For this option, same frequency resource is allocated for PRACH repetitions in the same PRACH slot.

In another option, frequency hopping pattern for multiple PRACH transmissions can be determined in accordance with relative subframe index, or relative 60 kHz slot index and/or relative or absolute system frame index. In some aspects, for relative subframe index, first subframe used for a first PRACH repetition is 0, and relative subframe index for other subframes used for the PRACH repetition is defined relative to the first subframe used for the first PRACH repetition. In an example, the first subframe used for a first PRACH transmission may be identified with respect to an absolute time reference, e.g., one or more combinations of: system frame number, subframe number, slot number for a given numerology, e.g., the numerology of the initial UL BWP, or the numerology of the PRACH transmissions, etc., or relative to another time reference, e.g., of a DL or UL channel or signal, e.g., the latest occasion of an associated SSB.

Similarly, for relative 60 kHz slot index, first 60 kHz slot used for a first PRACH repetition is 0, and relative 60 kHz slot index for other 60 kHz slot used for the PRACH repetition is defined relative to the first 60 kHz slot used for the first PRACH repetition.

Further, UE may switch the frequency resource in every K subframes or 60 kHz slots for multiple PRACH transmissions, where K can be predefined in the specification or configured by higher layer via RMSI, OSI, or RRC signaling. In one example, K=1, which indicates that UE switches the frequency resource in every subframes or 60 kHz slots. Alternatively, K can be determined in accordance with the number of repetitions. In one example, K=└N_{PRACH}^{Repeat}/2┘. For this option, same frequency resource is allocated for PRACH repetitions in the same subframes or 60 kHz slots.

In another option, frequency hopping pattern for multiple PRACH transmissions can be determined in accordance with relative system frame number. In some aspects, for relative system frame number, first system frame used for a first PRACH repetition is 0, and relative system frame number for other system frames used for the PRACH repetition is defined relative to the first system frame used for the first PRACH repetition. In an example, the first system frame used for a first PRACH transmission may be identified with respect to an absolute time reference, e.g., one or more combinations of: system frame number, subframe number, slot number for a given numerology, e.g., the numerology of the initial UL BWP, or the numerology of the PRACH transmissions, etc., or relative to another time reference, e.g., of a DL or UL channel or signal, e.g., the latest occasion of an associated SSB.

Further, UE may switch the frequency resource in every K system frame for multiple PRACH transmissions, where K can be predefined in the specification or configured by higher layer via RMSI, OSI, or RRC signaling. In one example, K=1, which indicates that UE switches the frequency resource in every system frame. Alternatively, K can be determined in accordance with the number of repetitions. In one example, K=└N_{PRACH}^{Repeat}/2┘. For this option, same frequency resource is allocated for PRACH repetitions in the same system frame.

In another embodiment, frequency hopping pattern is determined prior to any cancellation or dropping of PRACH transmission on the valid PRACH occasion. In some aspects, the cancellation of dropping of the PRACH transmission may be defined in accordance with the rule in Section 11.1 in TS 38.213. In one example, when a PRACH transmission overlaps with DL symbols which are configured by UE-specific TDD UL DL configuration, the PRACH transmission may be dropped.

In another embodiment, frequency hopping pattern is determined after any cancellation or dropping of PRACH transmission on the valid PRACH occasion. In some aspects, the cancellation of dropping of the PRACH transmission may be defined in accordance with the rule in Section 11.1 or 17.2 in TS 38.213 . In one option, the cancellation or dropping of PRACH transmission on the valid PRACH occasion is determined by UE-specific TDD UL DL configuration. In another option, the cancellation or dropping of PRACH transmission on the valid PRACH occasion is determined by UE-specific TDD UL DL configuration and SFI. In another option, the cancellation or dropping of PRACH transmission on the valid PRACH occasion is determined by UE-specific TDD UL DL configuration, SFI and DCI for dynamic DL reception.

In another embodiment, for a half-duplex RedCap UE, if the UE would transmit a PRACH repetition triggered by higher layers in a set of symbols and would receive a PDCCH, or a PDSCH, or a CSI-RS, or a DL PRS, or is indicated presence of SS/PBCH blocks within the active DL BWP by ssb-PositionsInBurst in SIB1 or in ServingCellConfigCommon or by NonCellDefiningSSB in symbols that include any symbol from the set of symbols, the PRACH repetition is cancelled and is not counted toward the configured number of PRACH repetitions.

In another embodiment, for half-duplex RedCap UE, if the UE receive a PDCCH, or a PDSCH, or a CSI-RS, or a DL PRS based on a configuration by higher layers or is indicated presence of SS/PBCH blocks within the active DL BWP by ssb-PositionsInBurst in SIB1 or in ServingCellConfigCommon or by NonCellDefiningSSB in a set of symbols, and the HD-UE would transmit a PRACH repetition triggered by higher layers starting or ending at a symbol that is earlier or later than N_{Rx-Tx}·T_{c} or N_{Tx-Rx}·T_{c}respectively, from the last or first symbol in the set of symbols, the PRACH repetition is cancelled and is not counted toward the configured number of PRACH repetitions.

In another embodiment, for half-duplex RedCap UE, if the UE would transmit a PRACH repetition triggered by higher layers in a set of symbols and would receive a PDCCH, or a PDSCH, or a CSI-RS, or a DL PRS, or is indicated presence of SS/PBCH blocks within the active DL BWP by ssb-PositionsInBurst in SIB1 or in ServingCellConfigCommon or by NonCellDefiningSSB in symbols that include any symbol from the set of symbols, the PRACH repetition cancelled but is counted toward the configured number of PRACH repetitions.

In another embodiment, for half-duplex RedCap UE, if the UE receive a PDCCH, or a PDSCH, or a CSI-RS, or a DL PRS based on a configuration by higher layers or is indicated presence of SS/PBCH blocks within the active DL BWP by ssb-PositionsInBurst in SIB1 or in ServingCellConfigCommon or by NonCellDefiningSSB in a set of symbols, and the HD-UE would transmit a PRACH repetition triggered by higher layers starting or ending at a symbol that is earlier or later than N_{Rx-Tx}·T_{c} or N_{Tx-Rx}·T_{c}, respectively, from the last or first symbol in the set of symbols, the PRACH repetition is cancelled but is counted toward the configured number of PRACH repetitions.

FIG. 4 illustrates a functional block diagram of a wireless communication device, in accordance with some embodiments. Wireless communication device 400 may be suitable for use as a UE or gNB configured for operation in a 5G NR or 6G network. The wireless communication device 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device. In some embodiments, the wireless communication device 400 may be configured for Ultra-High Reliability (UHR) communications in accordance with a IEEE 802.11 (e.g., WiFi 8).

The wireless communication device 400 may include communications circuitry 402 and a transceiver 410 for transmitting and receiving signals to and from other communication devices using one or more antennas 401. The communications circuitry 402 may include circuitry that can operate the physical layer (PHY) communications and/or medium access control (MAC) communications for controlling access to the wireless medium, and/or any other communications layers for transmitting and receiving signals. The wireless communication device 400 may also include processing circuitry 406 and memory 408 arranged to perform the operations described herein. In some embodiments, the communications circuitry 402 and the processing circuitry 406 may be configured to perform operations detailed in the above figures, diagrams, and flows.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the wireless communication device 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device, read-only memory (ROM), random-access memory (RAM), magnetic disk storage media, optical storage media, flash-memory devices and other storage devices and media.

In some embodiments, the wireless communication device 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 400 may include one or more of a keyboard, a display, a non-volatile memory port, multiple antennas, a graphics processor, an application processor, speakers, and other mobile device elements. The display may be an LCD screen including a touch screen.

Although the wireless communication device 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 400 may refer to one or more processes operating on one or more processing elements.

Wireless communication device 400 may be a user equipment (UE) configured for operation in a fifth-generation (5G) new radio (NR) network that may perform frequency hopping for physical random access channel (PRACH) repetition for a four-step random access channel (RACH) procedure. The UE may encode a PRACH preamble for multiple PRACH transmissions of the PRACH repetition in accordance with the number of repetitions and each of the multiple PRACH transmissions of the PRACH repetition may be transmitted in accordance with frequency hopping. Each of the multiple PRACH transmissions comprises a same PRACH preamble transmitted in each of a plurality of PRACH occasions.

### EXAMPLES

Example 1 may include a method of wireless communication for a fifth generation (5G) or new radio (NR) system, the method comprising: receiving, by a UE from a gNodeB (gNB), a configuration of a number of repetitions and frequency hopping for a physical random access channel (PRACH); and performing, by the UE, frequency hopping for the PRACH with the configured number of repetitions.

Example 2 may include the method of example 1 or some other example herein, wherein whether frequency hopping for multiple PRACH transmission is enabled or disabled can be configured by higher layers via NR remaining minimum system information (RMSI), NR other system information (OSI) or dedicated radio resource control (RRC) signaling, dynamically indicated in the DCI, or a combination thereof.

Example 3 may include the method of example 1 or some other example herein, wherein a frequency resource offset can be configured by higher layers via NR remaining minimum system information (RMSI), NR other system information (OSI) or dedicated radio resource control (RRC) signaling, dynamically indicated in the DCI, or a combination thereof.

Example 4 may include the method of example 1 or some other example herein, wherein the frequency resource offset can be defined as the physical resource block (PRB) offset or the PRACH frequency resource offset n_{RA}^{offset}.

Example 5 may include the method of example 1 or some other example herein, wherein PRACH repetitions mapped to PRACH occasions that may be invalid and/or cancelled are counted towards the total number of PRACH repetitions.

Example 6 may include the method of example 1 or some other example herein, wherein PRACH repetitions mapped to PRACH occasions that may be invalid and/or cancelled are not counted towards the total number of PRACH repetitions.

Example 7 may include the method of example 1 or some other example herein, wherein frequency hopping pattern for multiple PRACH transmissions can be determined in accordance with the valid time-domain PRACH occasion index used for multiple PRACH transmissions.

Example 8 may include the method of example 1 or some other example herein, wherein UE switches the frequency resource in every K valid time-domain PRACH occasions for multiple PRACH transmissions, where K can be predefined in the specification or configured by higher layer via RMSI, OSI, or RRC signaling.

Example 9 may include the method of example 1 or some other example herein, wherein frequency hopping pattern for multiple PRACH transmissions can be determined in accordance with one or more following index: physical slot index, PRACH slot index, subframe index, 60 kHz slot index in a system frame and absolute system frame number.

Example 10 may include the method of example 1 or some other example herein, wherein frequency hopping pattern for multiple PRACH transmissions can be determined in accordance with PRACH slot index and/or system frame index.

Example 11 may include the method of example 1 or some other example herein, wherein frequency hopping pattern for multiple PRACH transmissions can be determined in accordance with subframe index, or 60 kHz slot index and/or system frame index.

Example 12 may include the method of example 1 or some other example herein, wherein frequency hopping pattern for multiple PRACH transmissions can be determined in accordance with system frame number.

Example 13 may include the method of example 1 or some other example herein, wherein frequency hopping pattern for multiple PRACH transmissions can be determined in accordance with one or more following index: relative physical slot index, relative PRACH slot index, relative subframe index, relative 60 kHz slot index in a system frame and system frame number.

Example 14 may include the method of example 1 or some other example herein, wherein frequency hopping pattern for multiple PRACH transmissions can be determined in accordance with relative PRACH slot index and/or relative or absolute system frame index.

Example 15 may include the method of example 1 or some other example herein, wherein frequency hopping pattern for multiple PRACH transmissions can be determined in accordance with relative subframe index, or relative 60 kHz slot index and/or relative or absolute system frame index.

Example 16 may include the method of example 1 or some other example herein, wherein frequency hopping pattern for multiple PRACH transmissions can be determined in accordance with relative system frame number.

Example 17 may include the method of example 1 or some other example herein, wherein frequency hopping pattern is determined prior to any cancellation or dropping of PRACH transmission on the valid PRACH occasion.

Example 18 may include the method of example 1 or some other example herein, wherein frequency hopping pattern is determined after any cancellation or dropping of PRACH transmission on the valid PRACH occasion.

Example 19 may include a method of a user equipment (UE), the method comprising: receiving configuration information for a physical random access channel (PRACH), wherein the configuration information indicates a number of repetitions of the PRACH and whether frequency hopping is enabled or disabled for the repetitions; and transmitting the PRACH with repetitions based on the configuration information.

Example 20 may include the method of example 19 or some other example herein, wherein the configuration information further indicates a frequency resource offset for the PRACH with frequency hopping.

Example 21 may include the method of example 19-20 or some other example herein, wherein the configuration information is received via NR remaining minimum system information (RMSI), NR other system information (OSI), dedicated radio resource control (RRC) signaling, downlink control information (DCI), or a combination thereof.

Example 22 may include the method of example 19-21 or some other example herein, wherein a frequency resource offset for the frequency hopping is defined as a physical resource block (PRB) offset or a PRACH frequency resource offaet n_{RA}^{offset}.

Example 23 may include the method of example 19-22 or some other example herein, wherein the repetitions that are mapped to PRACH occasions that are invalid or cancelled are counted towards a total number of PRACH repetitions.

Example 24 may include the method of example 19-22 or some other example herein, wherein the repetitions that are mapped to PRACH occasions that are invalid or cancelled are not counted towards a total number of PRACH repetitions.

Example 25 may include the method of example 19-24 or some other example herein, further comprising determining a frequency hopping pattern for the PRACH based on a valid time-domain PRACH occasion index used for multiple PRACH transmissions.

Example 26 may include the method of example 19-25 or some other example herein, wherein the transmitting includes switching a frequency resource in every K valid time-domain PRACH occasions for multiple PRACH transmissions.

Example 27 may include the method of example 26 or some other example herein, wherein K is predefined in the specification or configured (e.g., by higher layer via RMSI, OSI, or RRC signaling).

Example 28 may include the method of example 19-27 or some other example herein, further comprising determining a frequency hopping pattern for the repetitions based on one or more of a physical slot index, a PRACH slot index, a subframe index, a 60 kHz slot index in a system frame, or an absolute system frame number.

Example 29 may include the method of example 19-28 or some other example herein, further comprising determining a frequency hopping pattern for the PRACH based on one or more of a relative physical slot index, a relative PRACH slot index, a relative subframe index, a relative 60 kHz slot index in a system frame, or a system frame number.

Example 30 may include the method of example 19-29 or some other example herein, further comprising determining a frequency hopping pattern for the PRACH prior to any cancellation or dropping of a PRACH transmission on a valid PRACH occasion.

Example 31 may include the method of example 19-29 or some other example herein, further comprising determining a frequency hopping pattern for the PRACH after taking into account a cancellation or dropping of a PRACH transmission on a valid PRACH occasion.

Example 32 may include a method of a next generation Node B (gNB), the method comprising: encoding, for transmission to a user equipment (UE), configuration information for a physical random access channel (PRACH), wherein the configuration information indicates a number of repetitions of the PRACH and whether frequency hopping is enabled or disabled for the PRACH; and receiving the PRACH with repetitions and frequency hopping based on the configuration information.

Example 33 may include the method of example 32 or some other example herein, wherein the configuration information further indicates a frequency resource offset for the PRACH with frequency hopping.

Example 34 may include the method of example 32-33 or some other example herein, wherein the configuration information is transmitted via NR remaining minimum system information (RMSI), NR other system information (OSI), dedicated radio resource control (RRC) signaling, downlink control information (DCI), or a combination thereof.

Example 35 may include the method of example 32-34 or some other example herein, wherein a frequency resource offset for the frequency hopping is defined as a physical resource block (PRB) offset or a PRACH frequency resource offset n_{RA}^{offset}.

Example 36 may include the method of example 32-35 or some other example herein, wherein the repetitions that are mapped to PRACH occasions that are invalid or cancelled are counted towards a total number of PRACH repetitions.

Example 37 may include the method of example 32-35 or some other example herein, wherein the repetitions that are mapped to PRACH occasions that are invalid or cancelled are not counted towards a total number of PRACH repetitions.

Example 38 may include the method of example 32-37 or some other example herein, further comprising determining a frequency hopping pattern for the PRACH based on a valid time-domain PRACH occasion index used for multiple PRACH transmissions.

Example 39 may include the method of example 32-38 or some other example herein, wherein the receiving includes switching a frequency resource in every K valid time-domain PRACH occasions for multiple PRACH transmissions.

Example 40 may include the method of example 39 or some other example herein, wherein K is predefined in the specification or configured (e.g., by higher layer via RMSI, OSI, or RRC signaling).

Example 41 may include the method of example 32-40 or some other example herein, further comprising determining a frequency hopping pattern for the PRACH based on one or more of a physical slot index, a PRACH slot index, a subframe index, a 60 kHz slot index in a system frame, or an absolute system frame number.

Example 42 may include the method of example 32-41 or some other example herein, further comprising determining a frequency hopping pattern for the PRACH based on one or more of a relative physical slot index, a relative PRACH slot index, a relative subframe index, a relative 60 kHz slot index in a system frame, or a system frame number.

Example 43 may include the method of example 32-42 or some other example herein, wherein a frequency hopping pattern for the PRACH is determined prior to any cancellation or dropping of a PRACH transmission on a valid PRACH occasion.

Example 44 may include the method of example 32-43 or some other example herein, wherein a frequency hopping pattern is determined for the PRACH after taking into account a cancellation or dropping of a PRACH transmission on a valid PRACH occasion.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a user equipment (UE) configured for operation in a fifth-generation (5G) new radio (NR) network, the apparatus comprising: processing circuitry; and memory, wherein the processing circuitry is configured to:
decode signalling received from a generation Node B (gNB) to configure the UE for frequency hopping for physical random access channel (PRACH) repetition for a four-step random access channel (RACH) procedure, the signalling including a number of repetitions; and
encode a PRACH preamble for multiple PRACH transmissions of the PRACH repetition in accordance with the number of repetitions,
wherein each of the multiple PRACH transmissions of the PRACH repetition is transmitted in accordance with the frequency hopping,
wherein each of the multiple PRACH transmissions comprises a same PRACH preamble transmitted in each of a plurality of PRACH occasions, and
wherein the memory is configured to store the PRACH preamble.

2. The apparatus of claim 1, wherein the signalling received from the gNB configures the UE for frequency hopping for PRACH repetition using a short PRACH format, the short PRACH format comprising a preamble with a short sequence having a length of 139.

3. The apparatus of claim 1, wherein the signalling received from the gNB configures the UE for frequency hopping for PRACH repetition using a long PRACH format, the long PRACH format comprising a preamble with a long sequence having a length of 839.

4. The apparatus of claim 1, wherein the processing circuitry is to configure the UE for transmission of the multiple PRACH transmissions in one or more different transmit beams or using one or more different spatial domain filters.

5. The apparatus of claim 1, wherein the signalling received from the gNB configures the UE for frequency hopping for PRACH repetition indicates a frequency resource offset for transmission of the PRACH preambles at different frequencies for the multiple PRACH transmissions, and
wherein the frequency resource offset comprises one of a physical resource block (PRB) offset or the PRACH frequency resource offset.

6. The apparatus of claim 1, wherein the processing circuitry is configured to determine a frequency resource offset for the frequency hopping based on a number of PRACH frequency resources provided by a message received from the gNB.

7. The apparatus of claim 1, wherein for the frequency hopping, the processing circuitry is configured to determine a frequency hopping pattern for the multiple PRACH transmissions in accordance with valid time-domain PRACH occasion indexes used for the multiple PRACH transmissions,
the valid time-domain PRACH occasion indexes being mapped to valid PRACH occasions and are associated with a PRACH occasion group.

8. The apparatus of claim 7 wherein the processing circuitry is configured to refrain from including any PRACH repetitions in the PRACH occasion group that are mapped to invalid PRACH occasions.

9. The apparatus of claim 8, wherein when the PRACH occasions are multiplexed in a frequency domain multiplexing (FDM) manner and each of the PRACH occasions are associated with an Synchronization Signal/PBCH block (SSB), the processing circuitry is to configure the UE to randomly select a first PRACH occasion from the PRACH occasion group for a first PRACH repetition and determine a second PRACH occasion based at least in part on a frequency resource offset.

10. The apparatus of claim 1, wherein the signalling to configure the UE for frequency hopping comprising one of a DCI format, dedicated RRC signalling, NR remaining minimum system information (RMSI), and NR other system information (OSI).

11. The apparatus of claim 1, wherein the multiple PRACH transmissions of the PRACH repetition transmitted in accordance with the frequency hopping are transmitted as part of the four-step RACH procedure.

12. The apparatus of claim 1, wherein the processing circuitry is further configured to transmit multiple PRACH transmissions of a PRACH repetition in accordance with frequency hopping as part of a beam failure recovery (BFR) procedure.

13. A computer-readable storage medium that stores instructions for execution by processing circuitry of a user equipment (UE) configured for operation in a fifth-generation (5G) new radio (NR) network, the processing circuitry configured to:
decode signalling received from a generation Node B (gNB) to configure the UE for frequency hopping for physical random access channel (PRACH) repetition for a four-step random access channel (RACH) procedure, the signalling including a number of repetitions; and
encode a PRACH preamble for multiple PRACH transmissions of the PRACH repetition in accordance with the number of repetitions,
wherein each of the multiple PRACH transmissions of the PRACH repetition is transmitted in accordance with the frequency hopping,
wherein each of the multiple PRACH transmissions comprises a same PRACH preamble transmitted in each of a plurality of PRACH occasions.

14. The computer-readable storage medium of claim 13, wherein the signalling received from the gNB configures the UE for frequency hopping for PRACH repetition using a short PRACH format, the short PRACH format comprising a preamble with a short sequence having a length of 139.

15. The computer-readable storage medium of claim 13, wherein the processing circuitry is to configure the UE for transmission of the multiple PRACH transmissions in one or more different transmit beams or using one or more different spatial domain filters.

16. The computer-readable storage medium of claim 13, wherein the signalling received from the gNB configures the UE for frequency hopping for PRACH repetition indicates a frequency resource offset for transmission of the PRACH preambles at different frequencies for the multiple PRACH transmissions, and
wherein the frequency resource offset comprises one of a physical resource block (PRB) offset or the PRACH frequency resource offset.

17. The computer-readable storage medium of claim 13, wherein the processing circuitry is configured to determine a frequency resource offset for the frequency hopping based on a number of PRACH frequency resources provided by a message received from the gNB.

18. The computer-readable storage medium of claim 13, wherein for the frequency hopping, the processing circuitry is configured to determine a frequency hopping pattern for the multiple PRACH transmissions in accordance with valid time-domain PRACH occasion indexes used for the multiple PRACH transmissions,
the valid time-domain PRACH occasion indexes being mapped to valid PRACH occasions and are associated with a PRACH occasion group,
wherein the processing circuitry is configured to refrain from including any PRACH repetitions in the PRACH occasion group that are mapped to invalid PRACH occasions.

19. An apparatus of a generation Node B (gNB) configured for operation in a fifth-generation (5G) new radio (NR) network, the apparatus comprising: processing circuitry; and memory, wherein the processing circuitry is configured to:
encode signalling for transmission to a user equipment (UE) to configure the UE for frequency hopping for physical random access channel (PRACH) repetition for a four-step random access channel (RACH) procedure, the signalling including a number of repetitions; and
decode a PRACH preamble received from the UE in multiple PRACH transmissions of the PRACH repetition in accordance with the number of repetitions,
wherein each of the multiple PRACH transmissions of the PRACH repetition is received at different frequencies in accordance with the frequency hopping,
wherein each of the multiple PRACH transmissions comprises a same PRACH preamble transmitted in each of a plurality of PRACH occasions, and
wherein the memory is configured to store the PRACH preamble.

20. The apparatus of claim 19, wherein the PRACH preamble received from the UE in multiple PRACH transmissions comprises a short PRACH format, the short PRACH format comprising a preamble with a short sequence having a length of 139,
wherein the signalling to configure the UE for frequency hopping for PRACH repetition is encoded to indicate a frequency resource offset for transmission of the PRACH preambles at the different frequencies for the multiple PRACH transmissions, and
wherein the frequency resource offset comprises one of a physical resource block (PRB) offset or the PRACH frequency resource offset.
